(19) United States
(12) Patent Application Publication
(10) Pub. No.: US 2017/0236103 A1
(43) Pub. Date: Aug. 17, 2017

(54) Peer-to-Peer Financial Transactions Using A Private Distributed Ledger

(71) Applicant: D+H USA Corporation, Lake Mary, FL (US)

(72) Inventor: Eli Biton, Shoham (IL)

(21) Appl. No.: 15/430,407

(22) Filed: Feb. 10, 2017

Related U.S. Application Data
(60) Provisional application No. 62/294,815, filed on Feb. 12, 2016.

(51) Int. Cl. G06Q 20/06; G06Q 20/22

(52) U.S. Cl. CPC G06Q 20/065; G06Q 20/223

(57) ABSTRACT

Methods and systems for performing peer-to-peer financial transactions using a private distributed ledger are described. One example method includes identifying a non-accounting transaction in the blockchain network including an output address, zero output amount, a recall indicator, and an identifier of an original transaction; and in response to identifying, generating a reverse transaction crediting an input address of the original transaction for an output amount of the original transaction.

### CROSS-REFERENCE TO RELATED APPLICATION

This application claims the benefit under 35 U.S.C. §119(e)(1) of U.S. Provisional Application No. 62/294,815, filed on Feb. 12, 2016, which is incorporated by reference herein.

### BACKGROUND

A distributed ledger is a data structure that may be used by multiple entities to record and verify financial transactions. In some cases, the distributed ledger forms a tamper-resistant record of previously verified transactions. Various distributed currency schemes, such as Bitcoin and XRP, utilize public distributed ledgers to record and verify transactions between their users.

### SUMMARY

Methods and systems for performing peer-to-peer financial transactions using a private distributed ledger are described. One example method includes allocating an initial currency value to a genesis address, the initial currency value representing a maximum value of currency to be managed in the blockchain network; identifying a new member to add to the blockchain network; generating an address for the new member; and transferring an amount from the genesis address to the address for the new member, the transferred amount equaling an amount to be managed by the new member in the blockchain network. Another example method includes identifying a blockchain transaction sending a particular amount from a first address associated with a first entity to a second address associated with a second entity; and in response to identifying the blockchain transaction: generating a first transaction according to a specification of the first entity to debit an account associated with the first address by the particular amount; and generating a second transaction according to a specification of the second entity to credit an account associated with the second address by the particular amount. Another example method includes identifying a non-accounting transaction in the blockchain network including an output address, zero output amount, a recall indicator, and an identifier of an original transaction; and in response to identifying the blockchain transaction, generating a reverse transaction crediting the input address of the original transaction for the output amount of the original transaction.

Details of one or more implementations of the subject matter described in this specification are set forth in the accompanying drawings and the description below. Other features, aspects, and potential advantages of the subject matter will become apparent from the description, the drawings, and the claims.

### BRIEF DESCRIPTION OF THE DRAWINGS

FIG. 1 is a block diagram of a system in which a central bank creates a genesis block in a blockchain network.

FIG. 2 is a block diagram of a system showing an account database maintained by the central bank in the blockchain network.

FIG. 3 is a block diagram of a system showing a process for creating addresses for member institutions in the blockchain network.

FIG. 4 is a block diagram showing account databases maintained by member institutions in the blockchain network.

FIG. 5 is a block diagram of a system for creating an address for a first customer of a first member institution in the blockchain network.

FIG. 6 is a block diagram showing a process for creating an address for a second customer of a second member institution in the blockchain network.

FIG. 7 is a block diagram showing a process for handling a payment from the second customer to the first customer in the blockchain network.

FIG. 8 is a block diagram showing a system for reversing a payment from the second customer to the first customer in the blockchain network.

FIG. 9 is a flow chart showing a process for initializing a blockchain network and registering a member institution.

FIG. 10 is a flow chart showing a process for adjusting corresponding account balances at participating entities to reflect blockchain transactions.

FIG. 11 is a flow chart showing a process for reversing a previous blockchain transaction.

FIG. 12 is a diagram of computing devices that may be used to implement the systems and methods described in this document.

Like reference numbers and designations in the various drawings indicate like elements.

### DETAILED DESCRIPTION

The present disclosure is generally related to performing peer-to-peer financial transactions using a private distributed ledger. One example of a distributed ledger is a blockchain. For simplicity, the present disclosure will describe example implementations using a blockchain as a distributed ledger. However, the techniques described herein are not limited to blockchain technology, and are also applicable to other types of distributed ledgers.

A blockchain is a distributed ledger used to record financial transactions in the Bitcoin and other protocols. In some cases, a blockchain includes of a series of data structures known as blocks each including a set of financial transactions. Each block includes a header with a hash derived from the contents of all the transactions in the block. A new block is inserted at the end of the blockchain by including a hash of the header of the last block in the chain in a previous block field in the header of the new block. This arrangement ensures that a change to the contents of a particular block in the chain will render the hashes in the previous block field incorrect for every subsequent block in the blockchain, thereby ensuring the consistency of the structure.

The blockchain is generally published to computing nodes of entities participating in the distributed currency network. In the case of Bitcoin and other public distributed currency networks (e.g., Ethereum, Ripple), the blockchain is public. In some cases, the blockchain may be a private blockchain published only to entities participating in a private distributed currency network. In either case, the participating entities can verify new transactions simply by examining the contents of the blockchain, which includes the full financial record for all accounts in the network.

A blockchain begins with a genesis block which includes an initial total value of the asset to be managed by the chain. In Bitcoin, this genesis block includes an initial amount, and additional amounts are created as rewards for computing nodes that perform computations to create new blocks in the chain (known as “mining”). In a private blockchain, the genesis block may include the total value of all assets to be managed by the blockchain. The initial values may be associated with a default account for the blockchain.

As described above, each block in the blockchain includes details of multiple transactions. Each transaction takes the following form: payer X sends amount Y to payee Z. The payer and payee are identified using their public encryption keys (e.g., “addresses”), and, in some cases, the transaction is cryptographically signed with the private encryption key corresponding to the payee's public key. A transaction includes one payer or “input” and one or more payees or “outputs.” In a private blockchain, when a new entity begins participating in the blockchain, a transaction may be generated sending a portion of the initial value specified the genesis block from the default account to an account associated with the new entity.

For the purposes of the present disclosure, a “blockchain network” refers to a collection of financial entities (e.g., banks) utilizing a blockchain to record transaction among the entities themselves, or between among account holders of the entities.

The present disclosure describes a solution that enables banks and other entities to move money among themselves and among their account holders over a secured blockchain network. Once a transaction is sent to the blockchain network it is immediately settled and reflected in the bank's liquidity position in the blockchain scheme, with no need for an intermediary central authority to manage and with full transparency between all the peers in the network. The solution provides a utility for the members' banks to generate blockchain public addresses for their regulatory validated customers' accounts, manage internally the linkage between the customers' real account and their virtual addresses and grant these addresses in the blockchain network for sending and receiving money. Granted accounts' addresses can be used for sending and receiving payments without the need for reflecting and synchronizing the real accounts' balance in the blockchain virtual ledger. Thus, implementation of the solution does not impact the banks' core accounting systems and does not require any changes to these systems.

The solution also provides tools for creating the linkage between member's virtual accounts (address) and their real account with the entity or bank, displaying the member's blockchain current balance and monitoring and controlling the balance.

The present solution integrates existing payment technologies with the blockchain virtual ledger and secured peer to peer network technology to create a robust, efficient and secured platform for peer to peer money movement and settlement in a private network. With this platform, banks and other entities may be able to provide to their customers a better, safer and cheaper payment services.

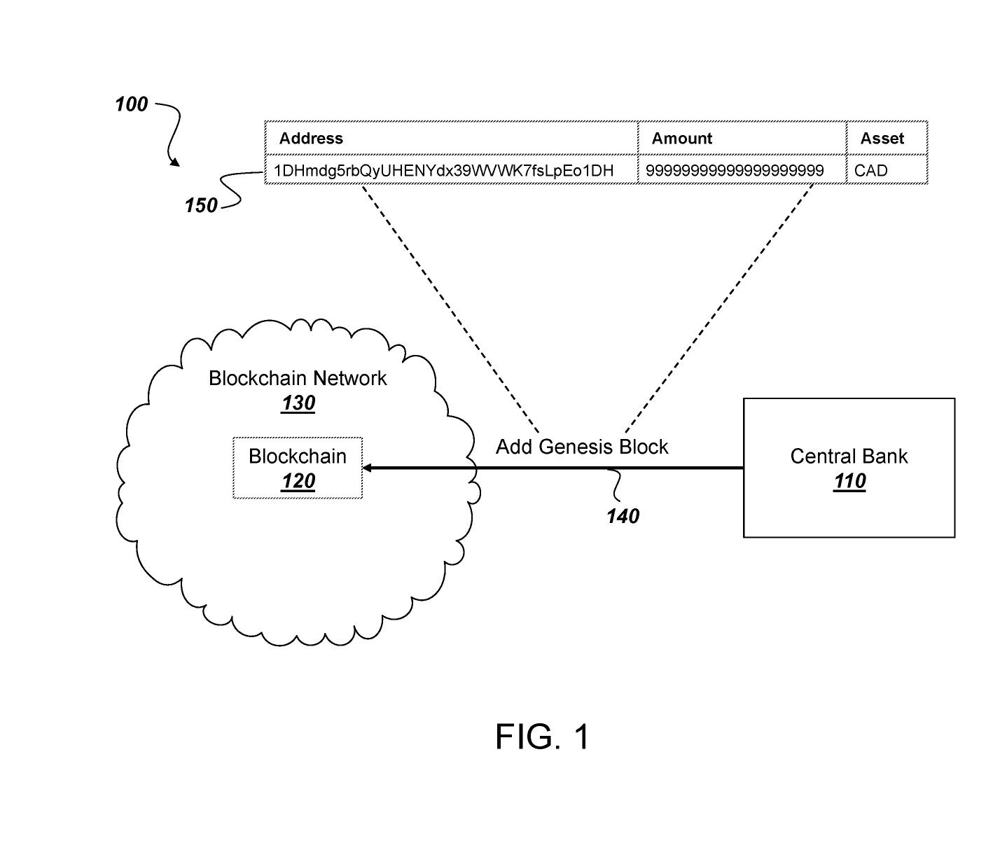

FIG. 1 is a block diagram of a system 100 in which a central bank 110 creates a genesis block 150 in a blockchain network 130. As shown, the system 100 includes a central bank 110 connected to a blockchain network 130. The blockchain network 130 includes a blockchain 120 that is accessible to all connected entities (such as the central bank 110). At 140, the central bank 110 creates a genesis block 150 and adds it to the blockchain 120. The genesis block 150 includes an address (the genesis address), an amount representing the total funds to be managed in the blockchain network, and an asset type indicating the type of currency to be managed (e.g., Canadian dollars (CAD), U.S. dollars (USD), etc.). In some implementations, the central bank may communicate with the blockchain network using various networking protocols, including Transmission Control Protocol (TCP), Internet Protocol (IP), Hypertext Transfer Protocol (HTTP), File Transfer Protocol (FTP), or other networking protocols. In some implementations, the genesis block 150 is the first block in the blockchain 120, and thus the central bank 110 may effectively create the blockchain 120 and initialize it to contain the genesis block 150. The central bank 110 may also append the genesis block 150 to an existing blockchain 120.

In some implementations, the system 100 issues a genesis address for each currency that the scheme will support and sets it with the amount that will define the maximum accumulation of all the members' balances at any given time. The system 100 may also register all network member addresses (banks) in the scheme and maintain a linkage between each member's virtual account (address) and their real account (e.g., at the participating entity or bank), as described below.

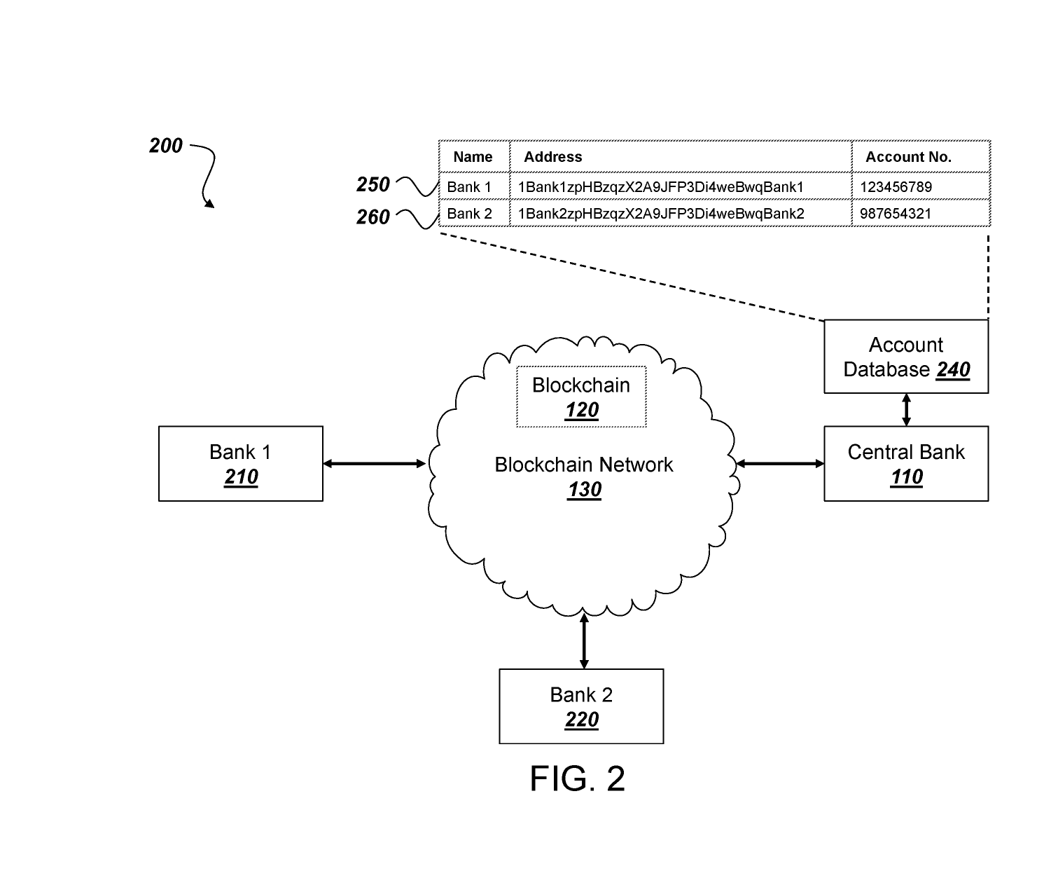

FIG. 2 is a block diagram of a system 200 showing an account database 240 maintained by the central bank 110 in the blockchain network 130. As shown, two member institutions 210 (Bank 1) and 220 (Bank 2) are connected to the blockchain network 120 along with the central bank 110. The central bank 110 maintains a linkage in the account database tying an account number for each member institution 210, 220 to a blockchain address for the institution. For example, row 250 in the account database 240 specifies that “Bank 1” is associated with blockchain address “1Bank1zpHBzqzX2A9JFP3Di4weBwqBank1,” and with account number “123456789.” In some implementations, this account number identifies an account held by the member institution with the central bank 110. Row 260 includes a similar association for “Bank 2.”

In some cases, the account database 240 may be a relational, object-oriented, or other type of database configured to store information about the member institutions 210, 220. The schema shown in FIG. 2 is exemplary, and other implementations may include additional or different data about the member institutions.

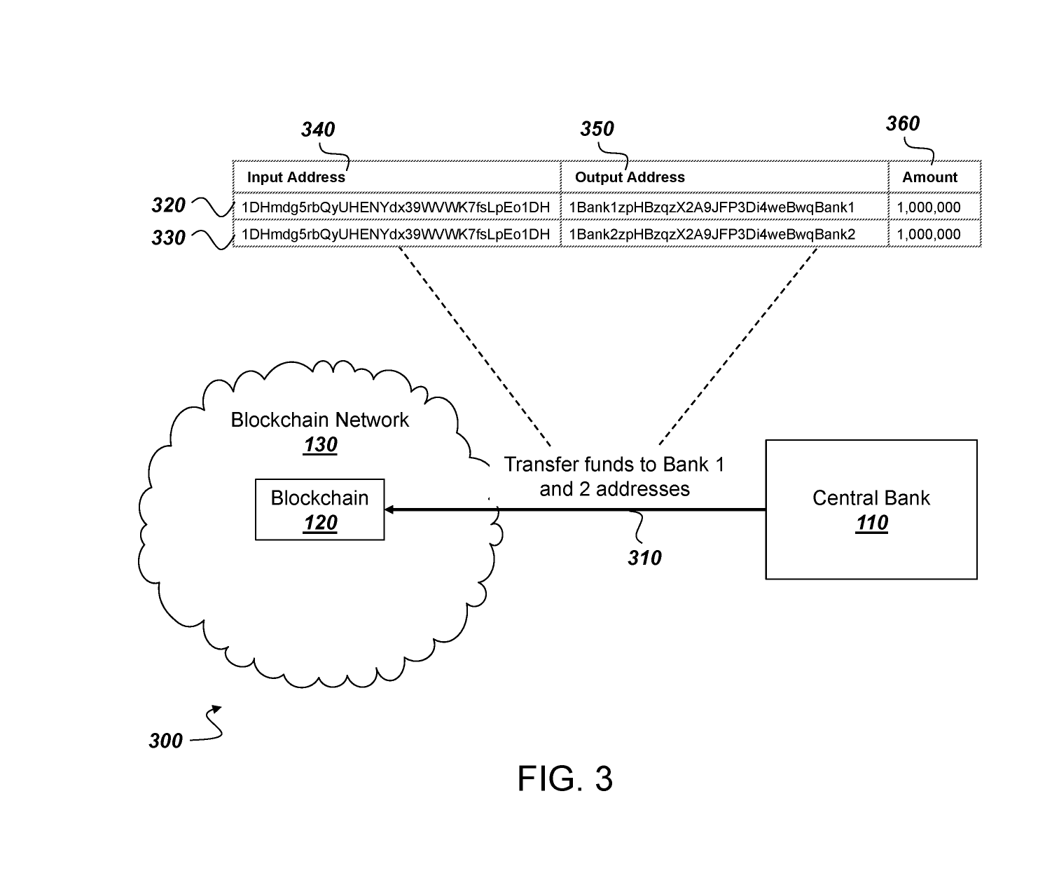

FIG. 3 is a block diagram of a system 300 showing a process for creating addresses for member institutions in the blockchain network 130. As shown, at 310, the central bank 110 appends two transactions 320, 330 to the blockchain 120. Each transaction 320, 330 includes an input address 340 specifying the address from which funds are being transferred, an output address 350 specifying the address to which funds are being transferred, and an amount being transferred by the particular transaction. Transaction 320 transfers an amount of “1,000,000” from the genesis address to the address for “Bank 1.” Transaction 330 transfers an amount of “1,000,000” from the genesis address to the address for “Bank 2.” These transactions are part of the registration of the member institutions 210, 220 from FIG. 2 (i.e., “Bank 1,” and “Bank 2”), and transfer an amount from the genesis address representing the total funds for each institution to be managed in the blockchain network 130.

In some cases, a single transaction may include multiple input addresses 340, multiple output addresses 360, and/or multiple amounts 360. For example, a single transaction could specify an input address X with an amount of 10,000, and an input address Y with an amount of 20,000. The transaction could then specify an output address of Z with an amount of 5,000,and another output address of A with an amount of 25,000. In such a transaction, address X would be debited by 10,000, address Y would be debited by 20,000, address Z would be credited by 5,000, and address A would be credited by 25,000.

In some implementations, the system 300 may include a blockchain position dashboard that reflects the actual position of the member's virtual account in the blockchain network and transactions held due to insufficient funds. From this dashboard a bank can initiate deposit and withdrawal requests. The system 700 also includes an automated process to initiate a deposit to the bank's central bank account that will trigger funding of the virtual account in the blockchain network.

In some implementations, the system 300 generates a transaction as per each bank's specifications, identifying the transaction based on member registration (at the particular bank) as a deposit to the blockchain and generating a blockchain transaction with input as the genesis address and output as the bank's address.

The system 300 may also include automated process to initiate a withdrawal of funds from the central bank account that will reduce the balance of the virtual account in the blockchain network. The bank affecting the withdrawal generates a blockchain transaction with input as the bank's address and output as the genesis address. The bank reads the next confirmed block, identifies transactions that are intended for itself (genesis address in output) and input from registered members. The bank generates a transaction, as per the bank's particular specifications, to credit the member's account at the bank.

Blockchain transactions that are rejected by the system are routed internally to the credit insufficient funds queue and alerts are generated. An automated procedure is invoked at regular intervals that checks the balance and releases transactions whose value can be settled.

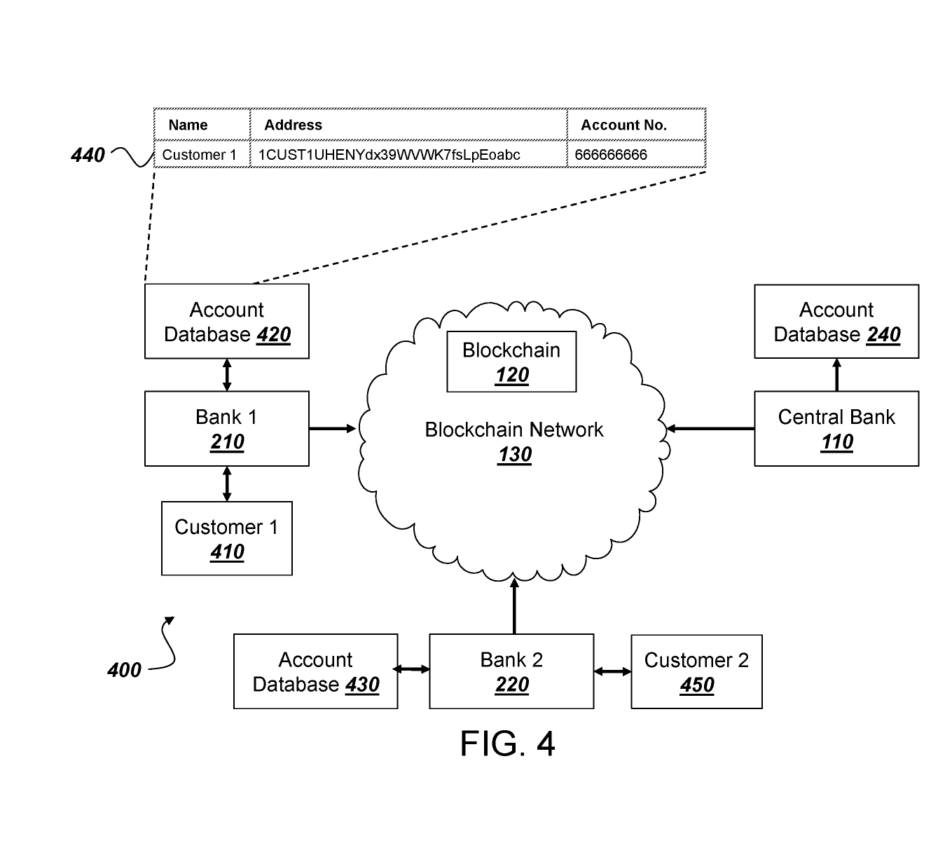

FIG. 4 is a block diagram showing account databases 420, 430 maintained by member institutions 210, 220 in the blockchain network 130. As shown, member institution 210 is associated with an account database 420, and member institution 220 is associated with an account database 430. Customers 410 and 450 are customers of member institutions 210 and 220, respectively. Member institution 210 creates an association 440 in the account database 420 linking a blockchain address for customer 410 to the customer's account number with member institution 210. Member institution 220 creates a similar association for customer 450 (not shown).

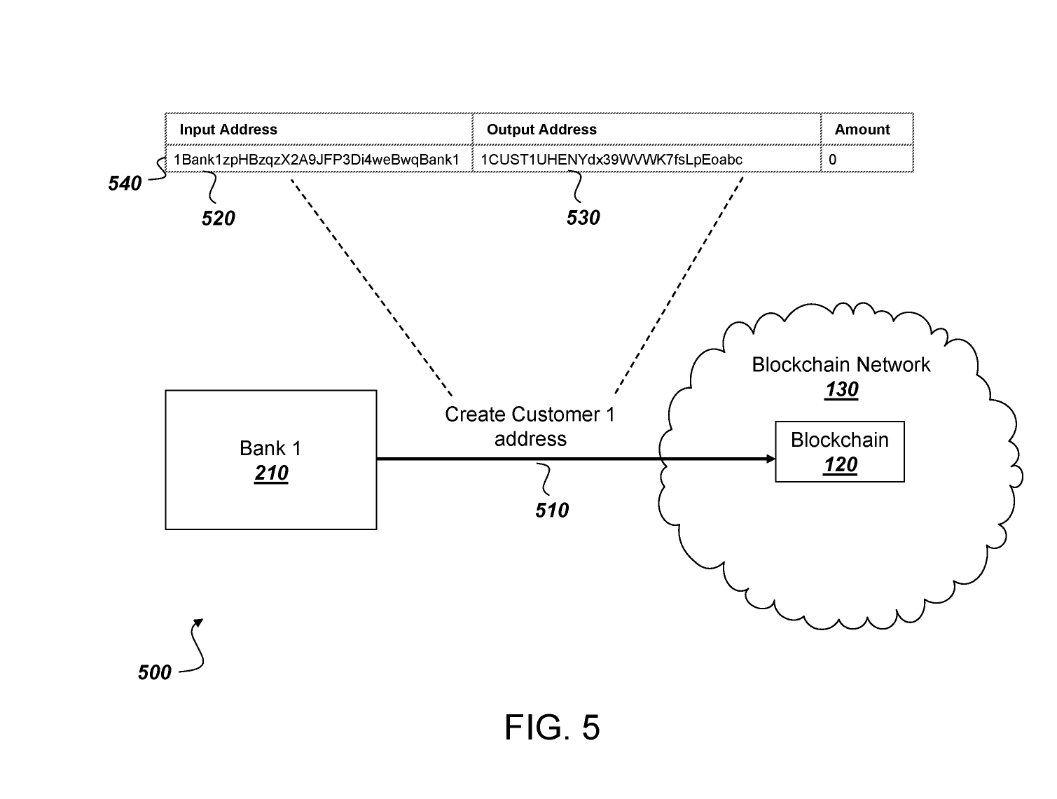

FIG. 5 is a block diagram of a system 500 for creating an address for a first customer of a first member institution 210 in the blockchain network 130. At 510, the member institution 210 adds a transaction 540 to the blockchain 120. The transaction 540 transfers a zero amount from the member institution's blockchain address 520 to a blockchain address 530 for the customer 410. In some cases, the member institution 210 may transfer an amount to the blockchain address 530 and then transfer the same amount back to its address. Some implementations may omit this step entirely, or may initialize blockchain addresses for customers of member institutions using different mechanisms appropriate for the particular blockchain network 130.

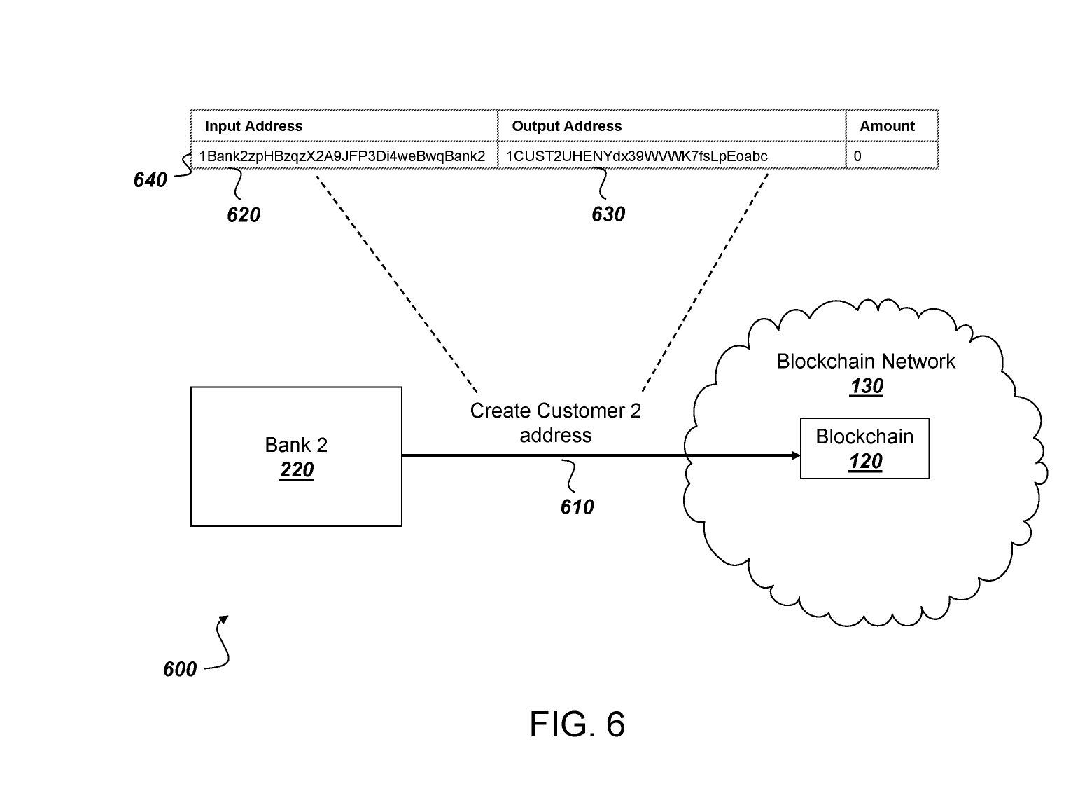

FIG. 6 is a block diagram showing a process for creating an address for a second customer of a second member institution in the blockchain network. At 610, the member institution 220 adds a transaction 640 to the blockchain 120. The transaction 640 transfers a zero amount from the member institution's blockchain address 620 to a blockchain address 630 for the customer 450. In some cases, the member institution 220 may transfer an amount to the blockchain address 630 and then transfer the same amount back to its address. Some implementations may omit this step entirely, or may initialize blockchain addresses for customers of member institutions using different mechanisms appropriate for the particular blockchain network 130.

In some implementations, an upload utility is also provided for the members' banks to generate blockchain public addresses for their regulatory validated customers' accounts, and to manage, internally, the linkage between the customers' real account and their virtual addresses and grant these addresses in the blockchain network for sending and receiving money. In some cases, the upload can be performed using full and/or incremental mode or by using a web service.

In some cases, a group of entities participating in a blockchain network may form a second blockchain network with a new blockchain in order to manage additional assets, as the genesis block generally includes the total value of the assets to be managed in a particular blockchain.

Blockchain transactions may be initiated in the present solution by the providing files, mixed files, single and manually created files. In some implementations, as part of payment processing, the system identifies the credit party and checks whether the creditor element in the transaction includes a properly formatted and registered address in the blockchain network. In such a case, the agent, with which the address and the party's real account is held, is not required to be identified in the transaction. Once the address is validated, the transaction is considered a candidate for settlement via the blockchain network. Using a rules engine in the system, the blockchain method of payment can be set to take precedence over other candidate methods of payment due to its lower cost and immediate settlement.

In order to maintain full transparency of the payer/payee details and yet avoid managing each of the customers' individual balances, the system may define a two-step blockchain transaction:

Step 1—input bank address, output initiating party

The Step 1 utilizes the bank's blockchain position balance and temporarily credits the initiating party's position. If the bank has an insufficient balance the Step 1 transaction is rejected by the blockchain system and the payment is routed to the insufficient funds queue (discussed above).

Step 2—input initiating party, output creditor address (multiple creditor addresses in case of file initiation)

Once the Step 1 transaction is sent successfully, the system may send the Step 2 transaction that utilizes the transaction output of Step 1 (initiating party balance).

In some implementations, the system reads the next confirmed block to identify outputs that credit the bank's customers. For efficiency, the system utilizes its de-bulking and parallel processing capabilities and splits all the transactions within the block into chunks that are processed concurrently. For each output address that exist in the bank's address list, the system extracts the real account number and performs the credit-side accounting. These outputs are aggregated as inputs and their total amount is mirrored in the output to the bank's address and sent back to the blockchain network, i.e. the bank's blockchain position is increased accordingly.

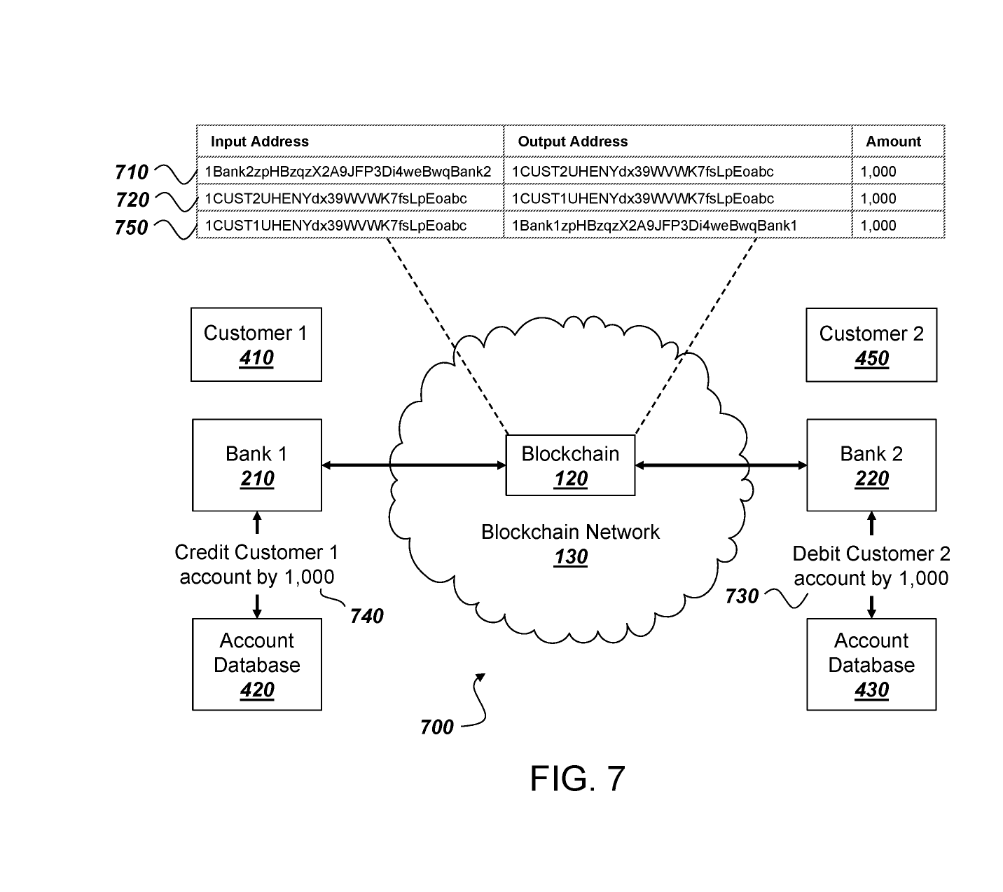

FIG. 7 is a block diagram showing a process for handling a payment from the second customer 450 to the first customer 410 in the blockchain network. In some implementations, when a payment is initiated from customer 450 to customer 410, member institution 220 first initiates a transaction 710 to transfer the amount of the payment from its blockchain address to the blockchain address for customer 450. This mechanism allows the member institution 220 to not have to maintain an accurate account balance for customer 450 in the blockchain network 130, as funds are transferred from the member institution's address when needed for a transaction. In some cases, the member institution 220 performs a check to see if the customer 450 has sufficient funds in its account with member institution 220 to cover the payment. If it does not have sufficient funds, transaction 710 is not created.

Member institution 220 then creates transaction 720 transferring an amount of 1,000 to the blockchain address for the customer 410. At 730, member institution 220 debits its account for customer 450 by the amount of the payment (1,000). At 740, in response to recognizing the transaction 720 in the blockchain 120, member institution 210 credits its account associated with customer 410 by the amount of the payment (1,000). Member institution 210 then creates transaction 750 transferring the amount of payment from the blockchain address of customer 410 to its blockchain address. As described above, this mechanism allows the member institution 210 to not have to maintain an accurate account balance for customer 410 in the blockchain network 130, as funds are transferred from the member institution's address when needed for a transaction.

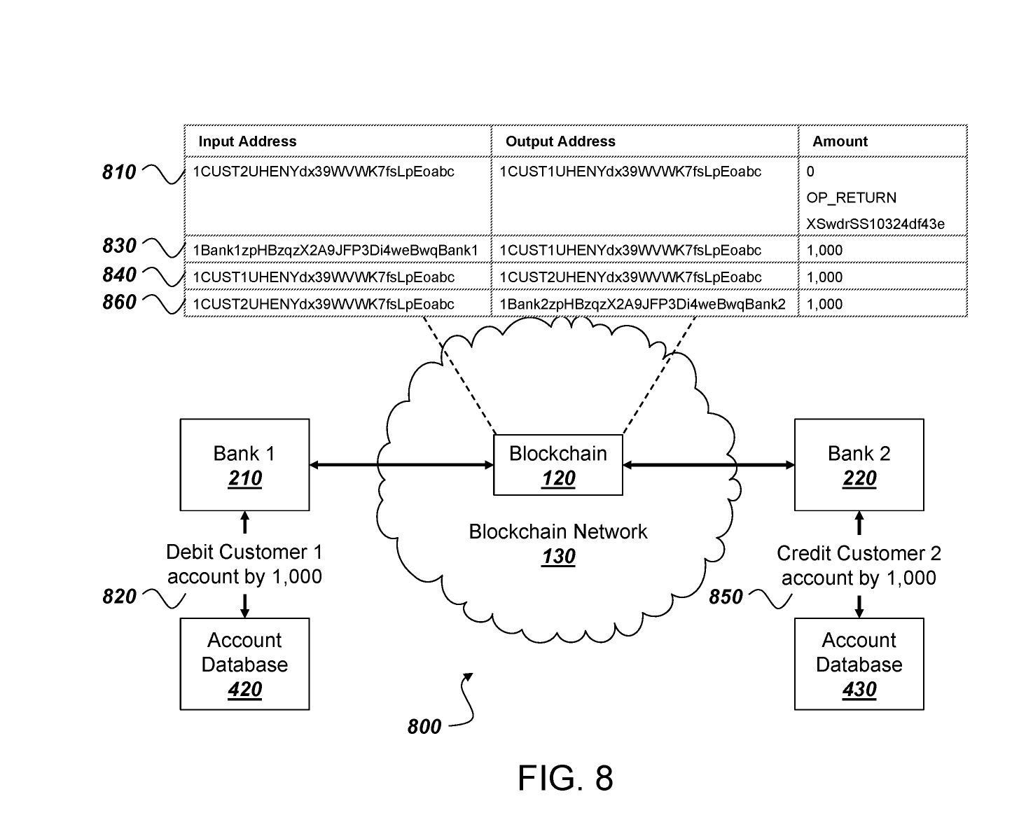

FIG. 8 is a block diagram showing a system 800 for reversing a payment from the second customer 450 to the first customer 410 in the blockchain network 130. In order to overcome the general limitation of blockchain networks where transactions are irrevocable, the system 800 includes a process for sending a recall request for a transaction from the originating member. In some implementations, a special non-accounting transaction 810 is sent to the blockchain network 130 that indicates the transaction ID to be recalled. The output address of the transaction is the same as the original sent transaction but with a zero value output amount and includes the OP_RETURN code followed by the original transaction ID.

On the receiving side, once the system identifies an output to the bank's address with the OP_RETURN followed by transaction ID, it attempts to match the recall request to the original transaction. The matched original transaction is routed to an approve recall queue and once the user proves approval, a reverse transaction is generated automatically and sent back to the blockchain network.

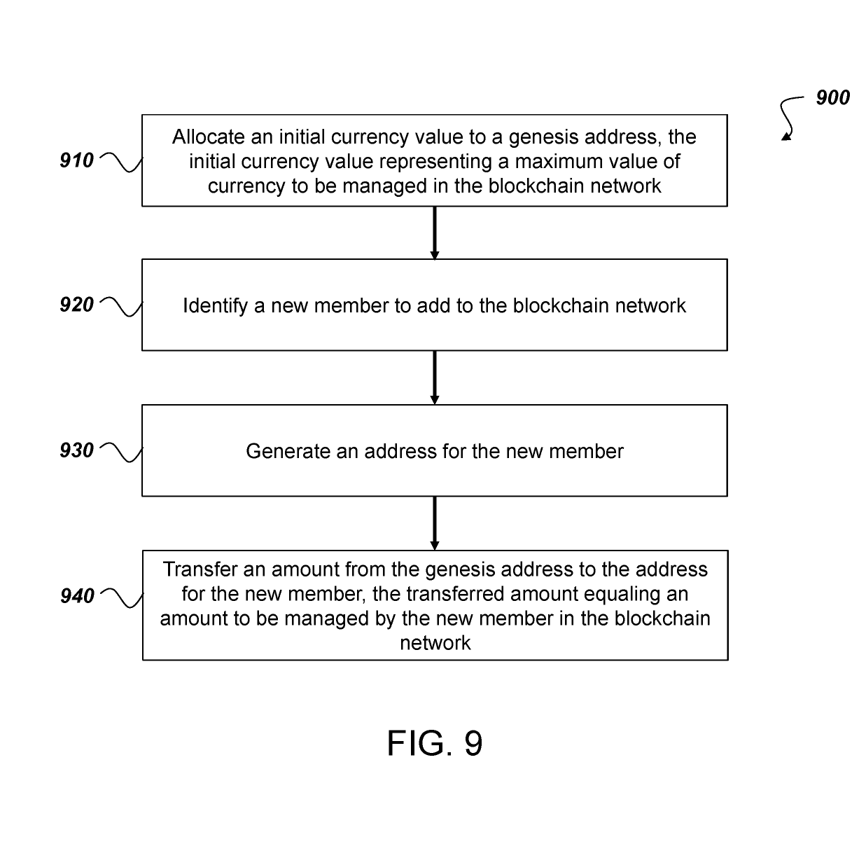

FIG. 9 is a flow chart showing a process for initializing a blockchain network and registering a member institution. At 910, an initial currency value is allocated to a genesis address, the initial currency value representing a maximum value of currency to be managed in the blockchain network. In some cases, allocating the initial currency value includes indicating a currency type for the currency value. At 920, a new member to add to the blockchain network is identified. At 930, an address for the new member is generated. At 940, an amount is transferred from the genesis address to the address for the new member, the transferred amount equaling an amount to be managed by the new member in the blockchain network.

In some cases, the allocating, identifying, generating, and transferring steps are performed by processors associated with a central bank. The new member may be a financial institution separate from the central bank.

In some cases, the blockchain network may be a Bitcoin network, a Ripple network, a Ethereum network, or other distributed ledger system.

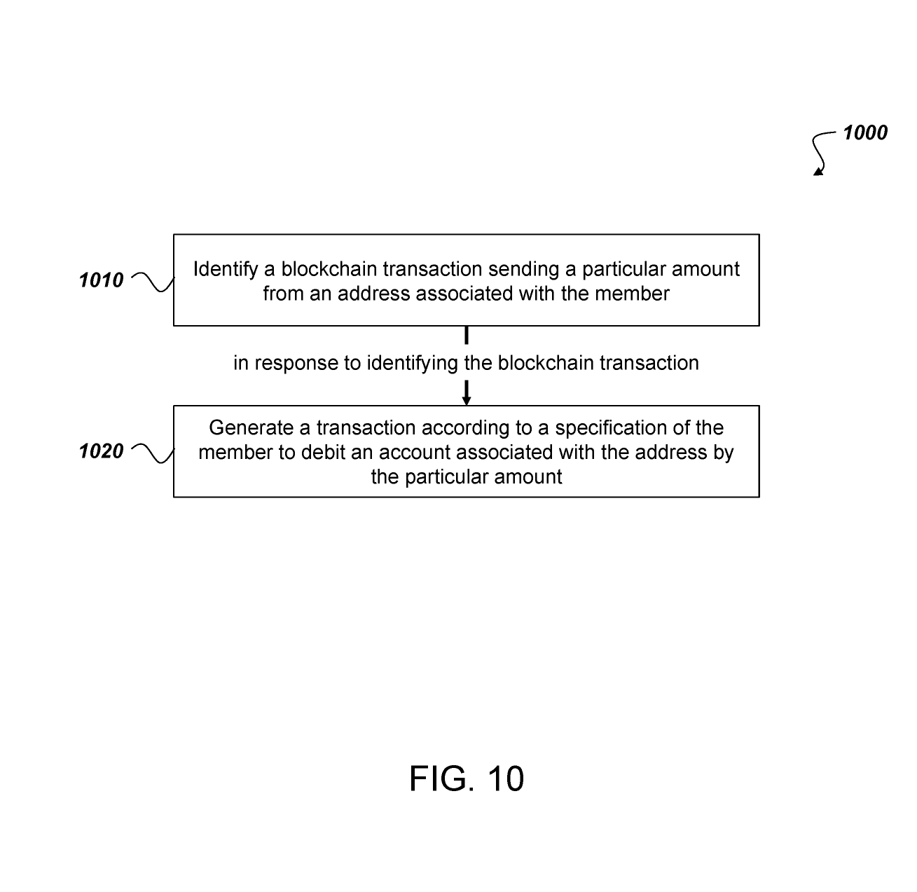

FIG. 10 is a flow chart showing a process for adjusting corresponding account balances at participating entities to reflect blockchain transactions. At 1010, a blockchain transaction sending a particular amount from a first address associated with a first entity to a second address associated with a second entity is identified. In some implementations, identifying the blockchain transaction includes identifying an account associated with the address in a database associated with the member.

At 1020, in response to identifying the blockchain transaction, a first transaction according to a specification of the first entity is generated to debit an account associated with the first address by the particular amount. At 1030, also in response to identifying the blockchain transaction, a second transaction according to a specification of the second entity is generated to credit an account associated with the second address by the particular amount.

In some cases, the member is a first member, the address is a first address, and the process 1000 includes identifying, by a second member of the blockchain network different than the first member, the blockchain transaction, wherein the blockchain transaction sends the particular amount from the first address to a second address associated with the second member; and in response to identifying the blockchain transaction, generating, by the second member, a transaction according to a specification of the second member to credit an account associated with the second address by the particular amount. In some cases, the first and second members are financial institutions. In some implementations, the account associated with the address is a bank account managed by the member.

In some cases, the process 1000 includes, in response to generating the transaction according to the specification of the second member, generating, by the second member, a blockchain transaction to transfer the particular amount from the second address to an address associated with the second member.

In some implementations, the blockchain network may be a Bitcoin network, a Ripple network, an Ethereum network, or other distributed ledger system.

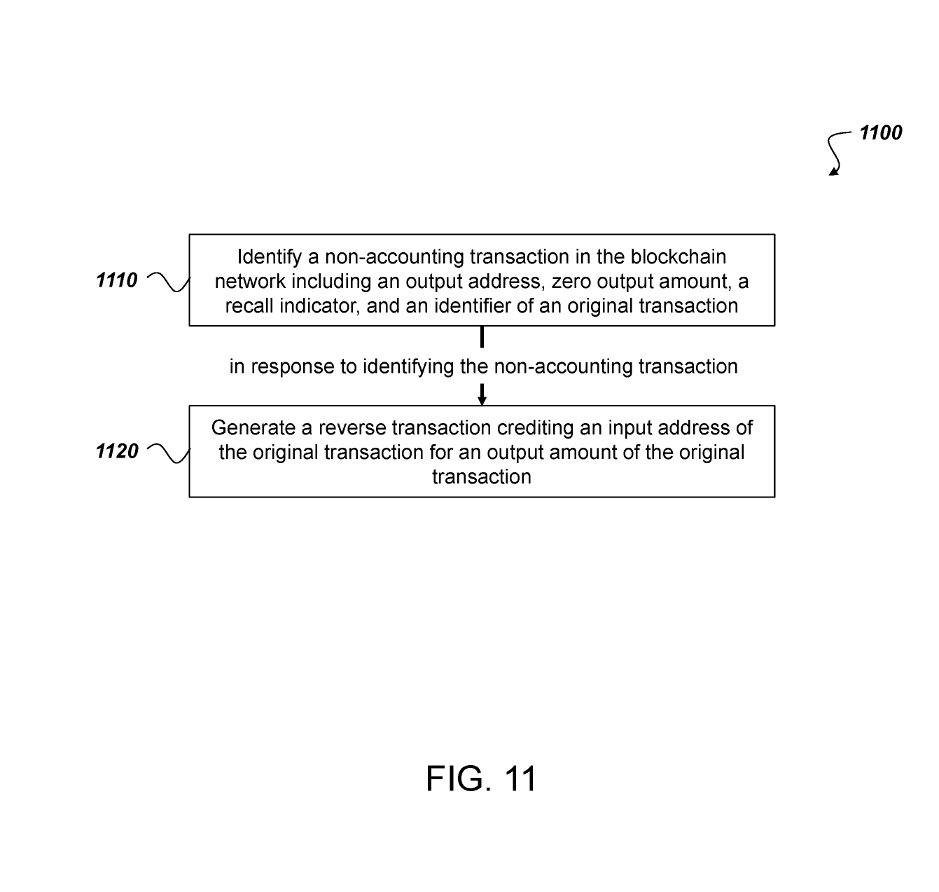

FIG. 11 is a flow chart showing a process for reversing a previous blockchain transaction. At 1110, a non-accounting transaction is identified in the blockchain network including an output address, zero output amount, a recall indicator, and an identifier of an original transaction. At 1120, in response to identifying the non-accounting transaction, a reverse transaction is generated crediting an input address of the original transaction for the output amount of the original transaction.

In some implementations, the process 1100 includes identifying the reverse transaction by a member of the blockchain network associated with the input address of the original transaction; and in response to identifying the reverse transaction, crediting, by the member, an account associated input address for the output amount of the original transaction.

In some cases, the process 1100 includes identifying the reverse transaction by a member of the blockchain network associated with the output address of the original transaction; and in response to identifying the reverse transaction, debiting, by the member, an account associated output address by the output amount of the original transaction.

In some cases, the member of the blockchain network is a financial institution, and the account associated with the output address is a bank account managed by the member. The account may be associated with the output address in an account database managed by the member.

In some implementations, the blockchain network may be a Bitcoin network, a Ripple network, an Ethereum network, or other distributed ledger system.

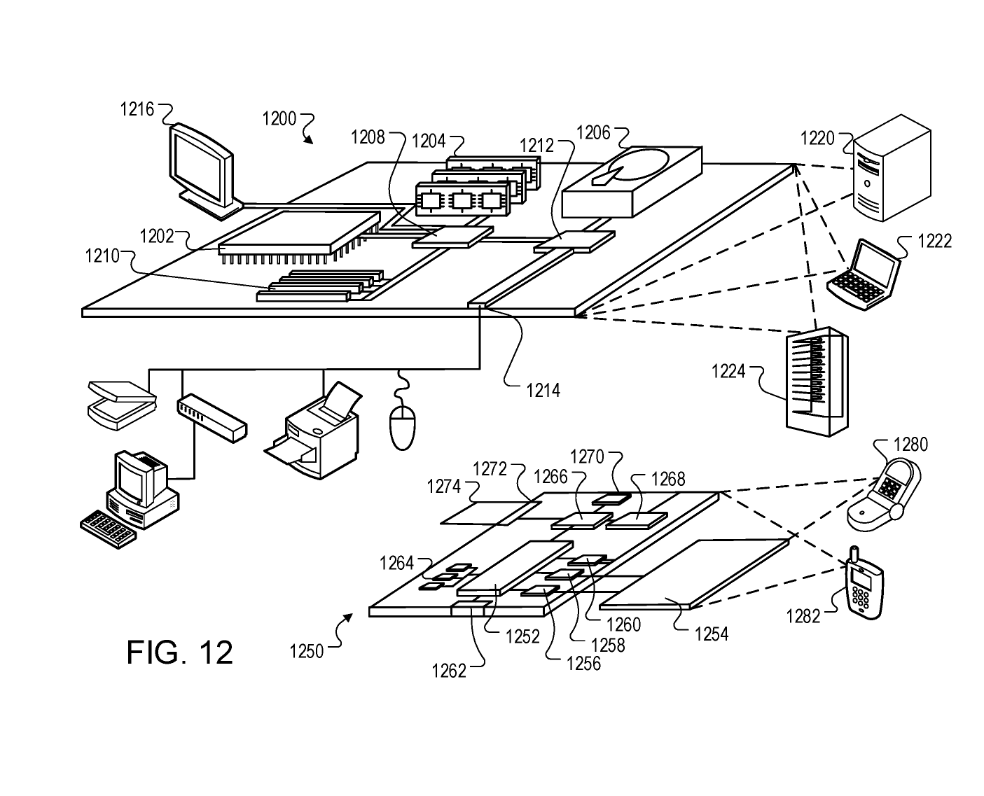

FIG. 12 is a block diagram of computing devices 1200, 1250 that may be used to implement the systems and methods described in this document, as either a client or as a server or plurality of servers. Computing device 1200 is intended to represent various forms of digital computers, such as laptops, desktops, workstations, personal digital assistants, servers, blade servers, mainframes, and other appropriate computers. Computing device 1250 is intended to represent various forms of mobile devices, such as personal digital assistants, cellular telephones, smartphones, and other similar computing devices. Additionally, computing device 1200 or 1250 can include Universal Serial Bus (USB) flash drives. The USB flash drives may store operating systems and other applications. The USB flash drives can include input/output components, such as a wireless transmitter or USB connector that may be inserted into a USB port of another computing device. The components shown here, their connections and relationships, and their functions, are meant to be exemplary only, and are not meant to limit implementations of the inventions described and/or claimed in this document.

Computing device 1200 includes a processor 1202, memory 1204, a storage device 1206, a high-speed interface 1208 connecting to memory 1204 and high-speed expansion ports 1210, and a low speed interface 1212 connecting to low speed bus 1214 and storage device 1206. Each of the components 1202, 1204, 1206, 1208, 1210, and 1212, are interconnected using various busses, and may be mounted on a common motherboard or in other manners as appropriate. The processor 1202 can process instructions for execution within the computing device 1200, including instructions stored in the memory 1204 or on the storage device 1206 to display graphical information for a GUI on an external input/output device, such as display 1216 coupled to high speed interface 1208. In other implementations, multiple processors and/or multiple buses may be used, as appropriate, along with multiple memories and types of memory. Also, multiple computing devices 1200 may be connected, with each device providing portions of the necessary operations (e.g., as a server bank, a group of blade servers, or a multi-processor system).

The memory 1204 stores information within the computing device 1200. In one implementation, the memory 1204 is a volatile memory unit or units. In another implementation, the memory 1204 is a non-volatile memory unit or units. The memory 1204 may also be another form of computer-readable medium, such as a magnetic or optical disk, or a flash memory or other similar solid state memory device.

The storage device 1206 is capable of providing mass storage for the computing device 1200. In one implementation, the storage device 1206 may be or contain a computer-readable medium, such as a hard disk device, an optical disk device, or a tape device, a flash memory or other similar solid state memory device, or an array of devices, including devices in a storage area network, a cloud computing network, or other configurations. A computer program product can be tangibly embodied in an information carrier. The computer program product may also contain instructions that, when executed, perform one or more methods, such as those described above. The information carrier is a computer- or machine-readable medium, such as the memory 1204, the storage device 1206, or memory on processor 1202.

The high speed controller 1208 manages bandwidth-intensive operations for the computing device 1200, while the low speed controller 1212 manages lower bandwidth-intensive operations. Such allocation of functions is exemplary only. In one implementation, the high-speed controller 1208 is coupled to memory 1204, display 1216 (e.g., through a graphics processor or accelerator), and to high-speed expansion ports 1210, which may accept various expansion cards (not shown). In the implementation, low-speed controller 1212 is coupled to storage device 1206 and low-speed expansion port 1214. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 1200 may be implemented in a number of different forms, as shown in the figure. For example, it may be implemented as a standard server 1220, or multiple times in a group of such servers. It may also be implemented as part of a rack server system 1224. In addition, it may be implemented in a personal computer such as a laptop computer 1222. Alternatively, components from computing device 1200 may be combined with other components in a mobile device (not shown), such as device 1250. Each of such devices may contain one or more of computing device 1200, 1250, and an entire system may be made up of multiple computing devices 1200, 1250 communicating with each other.

Computing device 1250 includes a processor 1252, memory 1264, an input/output device such as a display 1254, a communication interface 1266, and a transceiver 1268, among other components. The device 1250 may also be provided with a storage device, such as a microdrive or other device, to provide additional storage. Each of the components 1250, 1252, 1264, 1254, 1266, and 1268, are interconnected using various buses, and several of the components may be mounted on a common motherboard or in other manners as appropriate.

The processor 1252 can execute instructions within the computing device 1250, including instructions stored in the memory 1264. The processor may be implemented as a chipset of chips that include separate and multiple analog and digital processors. Additionally, the processor may be implemented using any of a number of architectures. For example, the processor 1210 may be a CISC (Complex Instruction Set Computers) processor, a RISC (Reduced Instruction Set Computer) processor, or a MISC (Minimal Instruction Set Computer) processor. The processor may provide, for example, for coordination of the other components of the device 1250, such as control of user interfaces, applications run by device 1250, and wireless communication by device 1250.

Processor 1252 may communicate with a user through control interface 1258 and display interface 1256 coupled to a display 1254. The display 1254 may be, for example, a TFT (Thin-Film-Transistor Liquid Crystal Display) display or an OLED (Organic Light Emitting Diode) display, or other appropriate display technology. The display interface 1256 may comprise appropriate circuitry for driving the display 1254 to present graphical and other information to a user. The control interface 1258 may receive commands from a user and convert them for submission to the processor 1252. In addition, an external interface 1262 may be provided in communication with processor 1252, so as to enable near area communication of device 1250 with other devices. External interface 1262 may provide, for example, for wired communication in some implementations, or for wireless communication in other implementations, and multiple interfaces may also be used.

The memory 1264 stores information within the computing device 1250. The memory 1264 can be implemented as one or more of a computer-readable medium or media, a volatile memory unit or units, or a non-volatile memory unit or units. Expansion memory 1274 may also be provided and connected to device 1250 through expansion interface 1272, which may include, for example, a SIMM (Single In Line Memory Module) card interface. Such expansion memory 1274 may provide extra storage space for device 1250, or may also store applications or other information for device 1250. Specifically, expansion memory 1274 may include instructions to carry out or supplement the processes described above, and may include secure information also. Thus, for example, expansion memory 1274 may be provided as a security module for device 1250, and may be programmed with instructions that permit secure use of device 1250. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1264, expansion memory 1274, or memory on processor 1252 that may be received, for example, over transceiver 1268 or external interface 1262.

Device 1250 may communicate wirelessly through communication interface 1266, which may include digital signal processing circuitry where necessary. Communication interface 1266 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1268. In addition, short-range communication may occur, such as using a Bluetooth, WiFi, or other such transceiver (not shown). In addition, GPS (Global Positioning System) receiver module 1270 may provide additional navigation- and location-related wireless data to device 1250, which may be used as appropriate by applications running on device 1250.

Device 1250 may also communicate audibly using audio codec 1260, which may receive spoken information from a user and convert it to usable digital information. Audio codec 1260 may likewise generate audible sound for a user, such as through a speaker, e.g., in a handset of device 1250. Such sound may include sound from voice telephone calls, may include recorded sound (e.g., voice messages, music files, etc.) and may also include sound generated by applications operating on device 1250.

The computing device 1250 may be implemented in a number of different forms, as shown in the figure. For example, it may be implemented as a cellular telephone 1280. It may also be implemented as part of a smartphone 1282, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), peer-to-peer networks (having ad-hoc or static members), grid computing infrastructures, and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. In addition, the logic flows depicted in the figures do not require the particular order shown, or sequential order, to achieve desirable results. Other steps may be provided, or steps may be eliminated, from the described flows, and other components may be added to, or removed from, the described systems. Accordingly, other implementations are within the scope of the following claims.

What is claimed is:

1. A computer-implemented method executed by one or more processors for recalling a transaction in a blockchain network, the method comprising:
identifying a non-accounting transaction in the blockchain network including an output address, zero output amount, a recall indicator, and an identifier of an original transaction; and
in response to identifying, generating a reverse transaction crediting an input address of the original transaction for an output amount of the original transaction.

2. The method of claim 1, further comprising:
identifying the reverse transaction by a member of the blockchain network associated with the input address of the original transaction; and
in response to identifying the reverse transaction, crediting, by the member, an account associated input address for the output amount of the original transaction.

3. The method of claim 1, further comprising:
identifying the reverse transaction by a member of the blockchain network associated with the output address of the original transaction; and
in response to identifying the reverse transaction, debiting, by the member, an account associated output address by the output amount of the original transaction.

4. The method of claim 3, wherein the member of the blockchain network is a financial institution.

5. The method of claim 4, wherein the account associated with the output address is a bank account managed by the member.

6. The method of claim 5, wherein the account is associated with the output address in an account database managed by the member.

7. The method of claim 1, wherein the blockchain network is one of a Bitcoin network, a Ripple network, or an Ethereum network.

8. A non-transitory, computer-readable medium storing instructions operable when executed to cause at least one processor to perform operations comprising:
identifying a non-accounting transaction in the blockchain network including an output address, zero output amount, a recall indicator, and an identifier of an original transaction; and
in response to identifying, generating a reverse transaction crediting an input address of the original transaction for an output amount of the original transaction.

9. The computer-readable medium of claim 8, the operations further comprising:
identifying the reverse transaction by a member of the blockchain network associated with the input address of the original transaction; and
in response to identifying the reverse transaction, crediting, by the member, an account associated input address for the output amount of the original transaction.

10. The computer-readable medium of claim 8, the operations further comprising:
identifying the reverse transaction by a member of the blockchain network associated with the output address of the original transaction; and
in response to identifying the reverse transaction, debiting, by the member, an account associated output address by the output amount of the original transaction.

11. The computer-readable medium of claim 10, wherein the member of the blockchain network is a financial institution.

12. The computer-readable medium of claim 11, wherein the account associated with the output address is a bank account managed by the member.

13. The computer-readable medium of claim 12, wherein the account is associated with the output address in an account database managed by the member.

14. The computer-readable medium of claim 8, wherein the blockchain network is one of a Bitcoin network, a Ripple network, or an Ethereum network.

15. A system comprising:
memory for storing data; and
one or more processors operable to perform operations comprising:
identifying a non-accounting transaction in the blockchain network including an output address, zero output amount, a recall indicator, and an identifier of an original transaction; and
in response to identifying, generating a reverse transaction crediting an input address of the original transaction for an output amount of the original transaction.

16. The system of claim 15, the operations further comprising:
identifying the reverse transaction by a member of the blockchain network associated with the input address of the original transaction; and
in response to identifying the reverse transaction, crediting, by the member, an account associated input address for the output amount of the original transaction.

17. The system of claim 15, the operations further comprising:
identifying the reverse transaction by a member of the blockchain network associated with the output address of the original transaction; and
in response to identifying the reverse transaction, debiting, by the member, an account associated output address by the output amount of the original transaction.

18. The system of claim 17, wherein the member of the blockchain network is a financial institution.

19. The system of claim 18, wherein the account associated with the output address is a bank account managed by the member.

20. The system of claim 19, wherein the account is associated with the output address in an account database managed by the member.
